(19) United States
(12) Patent Application Publication
(10) Pub. No.: US 2025/0257778 A1
(43) Pub. Date: Aug. 14, 2025

(54) BLOCKING DEVICE

(71) Applicant: SUMITOMO RIKO COMPANY LIMITED, Aichi (JP)

(72) Inventors: Youssef IRAKI, Hanau (DE); Martin GROMES, Steinau (DE)

(21) Appl. No.: 19/044,714

(22) Filed: Feb. 4, 2025

(30) Foreign Application Priority Data
Feb. 12, 2024 (DE) 10 2024 103 835.7

(51) Int. Cl. F16F 7/00

(52) U.S. Cl. CPC F16F 7/00; F16F 2230/0041; F16F 2234/02

(57) ABSTRACT

A blocking device for a functional element provides a predetermined free space for the functional element. The blocking device includes a blocking extension which is expanded perpendicular to a cylinder axis and at least one holding portion which extends along the cylinder axis. The blocking device further includes at least one accumulation of material for fixing the functional element

### FIELD

The present disclosure relates to a blocking device for a functional element, in particular a damping device and/or decoupling device, such as is used in particular in motor vehicles, wherein a free space is provided for the functional element and/or damping or decoupling device.

### BACKGROUND

In the prior art, corresponding functional elements and/or damping or decoupling devices are used in motor vehicles in order for example to prevent vibrations from spreading within a motor vehicle, wherein a corresponding functional element is used between a vehicle body and a vibrating engine portion or other component in a motor vehicle which tends to vibrate and/or in relation to other regions in a motor vehicle.

WO 2020/001872 A1 for example discloses a vibration attenuation mechanism in which for example an engine and/or compressor is held within a linkage. The engine and/or compressor naturally causes vibrations while in operation, which can be disruptive in particular to the occupants of a motor vehicle. Accordingly, elastic elements are provided on joint-like structures within the mechanism, which connect to the body of the motor vehicle via elastomers. The elastomers decouple the body of the motor vehicle from the compressor as far as possible, i.e. the elastomers attenuate the vibrations emanating from the engine and/or compressor. The damping and/or decoupling devices proposed in this prior publication consist of various constituent parts which have to be joined together and assembled within suitable openings in the vibration attenuation mechanism. A required pre-assembly and the final assembly are comparatively complex and correspondingly costly.

The present disclosure may provide a blocking device which enables advantages in relation to pre-assembling and reliably finally placing a functional element, such as a damping device and/or decoupling device, in an installation space provided for it, preferably in a motor vehicle.

### SUMMARY

In accordance with an embodiment, a blocking device for a functional element, is provided which is equipped with a predetermined free space for the functional element. The blocking device further comprises a blocking extension which is expanded perpendicular to a cylinder axis of the functional element. The blocking device further comprises at least one holding portions which extend along the cylinder axis. The blocking device further comprises at least one accumulation of material for fixing the functional element in an installation space.

In accordance with an embodiment, the holding portions may advantageously comprise struts which are disposed in the direction of the cylinder axis of the blocking device.

In accordance with an embodiment, the accumulations of material can be manufactured from a polymeric material which exhibits good friction coefficients and permanently elastic properties, such as rubber, etc., and can in particular be injection-molded.

In accordance with an embodiment, the blocking extension may be expanded perpendicular to the cylinder axis and may advantageously be embodied in accordance with the installation space within the motor vehicle. The blocking extension may comprise a cover. The blocking extension can also be embodied in the manner of a star, an oval or in some other way, such that regions of the blocking extension enable the functional element to be fixed in the installation space intended for it.

In accordance with an embodiment, the blocking extension can be connected to the functional element in such a way that free spaces provided for decoupling the functional element before and after its final assembly can be limited in a defined way. This may be achieved by a gap between the blocking extension and the functional element which can be set by means of the accumulation of material. The gap may define the maximum deflections, displacements and vibrations of both the blocking device itself and the functional element in the direction of the cylinder axis of the blocking device which are possible in accordance with the embodiments.

The disclosed embodiments can be advantageously and cost-effectively used for all rotationally symmetrical functional elements and their installation spaces.

In accordance with an embodiment at least one accumulation of material for fixing the functional element in the corresponding installation space in the motor vehicle may reliably fix, for example fixedly clamp, the functional element in relation to pre-assembling and finally positioning the functional element in the installation space, wherein the accumulation of material preferably acts near the cylinder axis of the overall arrangement with regard to the functional element, in order to hold it. The accumulation of material can also latch the blocking device to the functional element. Other force-fit or positive-fit connections can also be used.

In accordance with an embodiment blocking extension may advantageously be connected to the functional element at a distance, i.e. across a gap, in the direction of the cylinder axis of the overall arrangement, in order to limit movements and/or vibrations of the functional element. This may serve to prevent extreme movements of the functional element and/or damping and/or decoupling device provided with permanently elastic elastomeric damping and/or decoupling portions, in order to prevent the elastomeric portions from being subjected to an excess load and therefore ageing excessively. This may increase the service life of the functional element.

In accordance with an embodiment of the blocking device, two blocking extensions are provided opposite each other in the direction of the cylinder axis, between which accumulations of material are provided on the inner-circumferential edges of the blocking extensions and/or holding portions which can be embodied as struts, wherein the functional element, in particular the damping and/or decoupling device, is held between the two plate-like and/or mushroom-like blocking extensions, and the plate-like and/or mushroom-like blocking extensions provide a distance and/or gap between the functional element and the respective mutually assigned surfaces of the blocking extensions on both sides, in order to define the maximum deflections of the functional element.

In accordance with an embodiment functional element can be pre-assembled using the accumulations of material on a correspondingly embodied blocking device, such that the functional element, in particular a damping and/or decoupling device, may be reliably and permanently joined and/or fitted together even before its final assembly. The two accumulations of material, which tense the corresponding constituent parts against each other in order for example to generate a holding force such as a clamping force, also may ensure that the functional element is securely fixed in position throughout the service life of the overall composition consisting of the blocking device in accordance with the disclosed embodiments and a functional element, in particular a damping and/or decoupling device.

In accordance with an embodiment, instead of an accumulation of material which provides a holding force, in particular a clamping force, in order to fix the functional element in position, an adhesive bond could also be used. Other forms of fixing are known to the person skilled in the art and can likewise be used, such as a latching connection achieved by correspondingly shaping the constituent parts which are to be connected.

The present embodiments are described in more detail below on the basis of figures and by referring to preferred embodiments, wherein identical reference signs in the different figures and embodiments denote identical constituent parts and thus need not be described multiple times.

### THE FIGURES SHOW

FIGS. 1a to 1c an embodiment, in a side view perpendicular to the cylinder axis Z;

FIG. 1b a plan view onto the view in accordance with FIG. 1a;

FIG. 1c a perspective view of the embodiment in accordance with FIGS. 1a and 1b;

FIG. 2a a side view of another embodiment;

FIG. 2b a view rotated about the cylinder axis Z by 90° with respect to the view in accordance with FIG. 2a;

FIG. 2c a plan view onto the embodiment in accordance with FIGS. 2a and 2b;

FIG. 3a a sectional representation schematically showing a functional element and a blocking device of an embodiment;

FIG. 3b a plan view onto the embodiment in accordance with FIG. 3a, wherein the sectional plane shown in accordance with FIG. 3a is placed along the plane indicated by A-A;

FIG. 4 a sectional view of another embodiment through a blocking device and a functional element, i.e. in particular a damping and/or decoupling device;

FIG. 5 a perspective plan view onto another embodiment of a blocking device together with a functional element.

### DETAILED DESCRIPTION

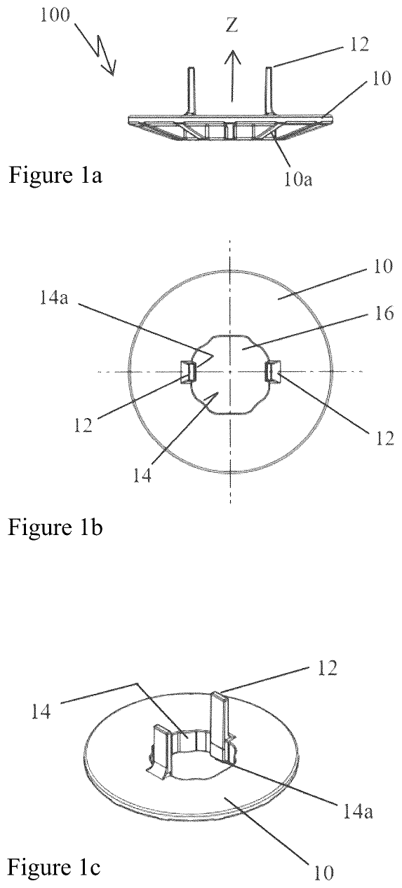

FIG. 1a shows a side view of a blocking device 100 in accordance with an embodiment. The blocking device 100 comprises a blocking extension 10 which is embodied as a cover and/or plate. Stabilizing struts 10a are provided in order to be able to embody the cover and/or plate 10 using as little material as possible, while at the same time providing sufficient stability. Two holding portions 12, which in this case are embodied as struts 12, extend from the cover and/or plate 10. A passage opening 16 for a connecting element, such as a retaining bolt (not shown), extends centrally with respect to and symmetrically around the cylinder axis Z, as can be seen from FIG. 1b. The passage opening 16 comprises an anti-twist holding projection 14, which provides a holding region, such as a clamping region, which can secure a functional element 22, such as a damping and/or decoupling device 22, in position. The accumulations of material 14 can for example be molded, for example injection-molded, from rubber. Various plastics may also be considered for this purpose. As can be seen, the passage opening 16 is not circular, but rather exhibits a contour which in the present case is embodied to be non-circular, in order for example to be able to accommodate and hold a sleeve 18 exhibiting a corresponding cross-sectionally non-circular shape, in particular in a rotationally secured way. A corresponding sleeve 18 can be embodied to comprise or to not comprise a structure, for example an internal thread, in order to hold a stud bolt.

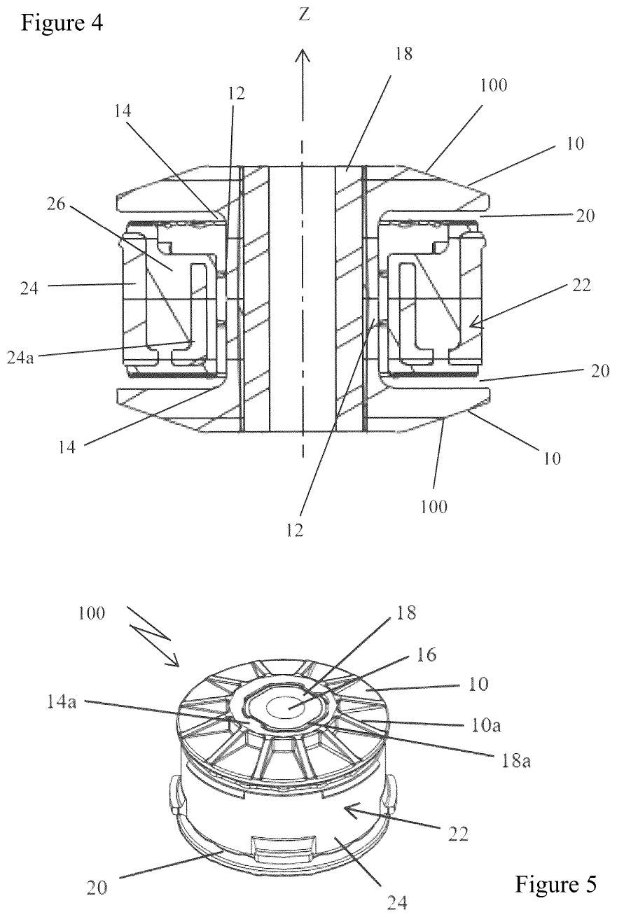

The perspective view in accordance with FIG. 1c shows inter alia a strut securing projection 14a which is configured to provide a correspondingly embodied sleeve 18 (see FIGS. 4 and 5) on the one hand and to secure a functional element 22, in particular a damping and/or decoupling device 22, in position on the other hand. Reference shall be made below to a decoupling device instead of the functional element 22, wherein this is also intended to refer equally to a damping device.

As can be seen, the decoupling device 22 is fixed relative to the blocking device 100 in accordance with an embodiment by the accumulations of material of the anti-twist holding projection 14 and/or strut securing projection 14a which provide clamping regions. Conversely, pre-assembly and securing the functional element in position after its final assembly can also be simplified by using an adhesive bond instead of the clamping regions.

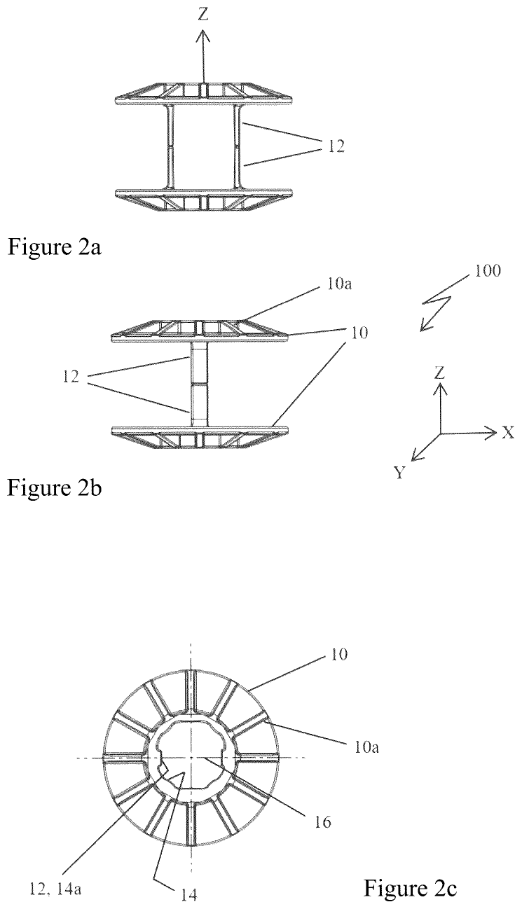

In the embodiment in accordance with FIGS. 2a to 2c, two blocking extensions 10 are provided which abut each other in the direction of the cylinder axis Z via two holding portions and/or struts 12 in each case. A damping device 22 can be accommodated between the two covers 10, and can in turn be held in position by corresponding accumulations of material, for example by clamping forces, as it is pre-assembled and in order to finally fix it. The struts 12 themselves can, but need not, abut against each other where they adjoin each other, since the respective upper and lower covers 10 are held on a decoupling device 22 (not shown here) by holding forces and are therefore held captively via the intercession of the decoupling device 22 (not shown here), for example by clamping forces.

As can be seen, both blocking devices 100 extend along the cylinder axis Z, and the covers 10 extend in the X-Y plane. A corresponding orientation is common to all of the embodiments shown.

The anti-twist holding projections 14, which provide the clamping regions 14 and in particular the clamping effect, and the strut securing projections 14a can be clearly seen in FIG. 2c.

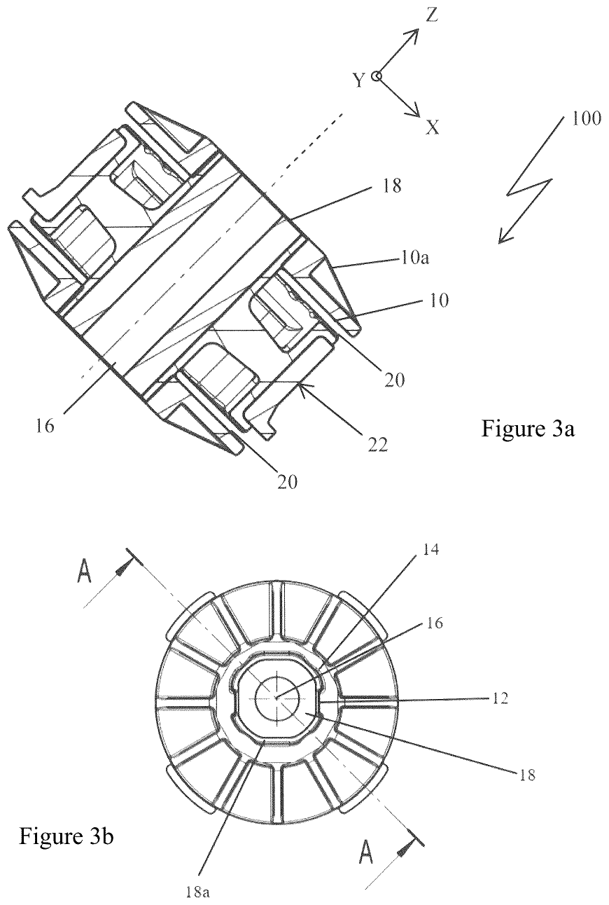

FIGS. 3a and 3b show a damping device 22 in addition to the constituent parts of the blocking device 100 in accordance with an embodiment. A gap 20 which defines maximum deflections of the decoupling device 22 while in operation and thus helps to limit the loads on the decoupling device 22, is provided between the decoupling device 22 and the respective covers 10 of the blocking device 100 in relation to each end surface of the decoupling device 22, respectively. The damping device 22 which is embodied to comprise elastomeric portions is thus not subjected to an excess load and can therefore avoid premature ageing. A sleeve 18 through which a retaining bolt (not shown) can be passed in order to acoustically decouple a vibrating part of a motor vehicle from other parts of the motor vehicle, is provided within the decoupling device 22 and within the passage opening 16 for a connecting element.

The specific embodiment of a decoupling device 22 is not crucial.

It can be seen that the sleeve 18 comprises flattened regions 18a on its outer circumference, which are embodied to correspond to the shape of the passage opening 16. This enables the struts 12 to provide a fixed mechanical bracket for the sleeve 18 on the one hand, and to secure against twisting on the other hand, such that the sleeve 18 is not able to rotate within the passage opening 16. The decoupling device 22 is clamped relative to the blocking device 100 in accordance with an embodiment by the anti-twist holding projections 14, which can also be referred to as clamping regions 14.

A decoupling device 22 is described in more detail in connection with FIG. 4, wherein a corresponding decoupling device 22 can in principle be embodied in any way, as long as it is embodied in a suitable way for the vibrations to be damped and the installation space available.

The decoupling device 22 comprises an outer connector sleeve 24 and an inner connector sleeve 24a. A permanently elastic elastomer portion 26 which performs the damping function is provided between these two sleeves 24, 24a. In the clamping regions 14 provided in the direction of the cylinder axis Z, accumulations of material which are provided in the region of the covers and/or in the region of the struts 12 hold and clamp the decoupling device 22.

In this case, again, the gaps 20 limit a deformation of the permanently elastic elastomer portions 26 in the direction of the Z axis.

FIG. 5 shows another embodiment, wherein in addition to the constituent parts already discussed, reference should also be additionally made to the fact that a retaining bolt (not shown) which can be passed through the free cross-section of the passage opening 16 is configured to hold the vibrating component to be decoupled, such as a compressor, engine or the like, on the body of a motor vehicle (not shown), while the decoupling device 22 absorbs vibrations, noise, etc. emanating from the part of the machine which is to be held, such as a compressor, while the blocking device 100 in accordance with the embodiment, which in this case likewise consists of two covers 10 and respectively two struts 12 (which cannot be seen), fixes the decoupling device both for pre-assembly and in its final position, preferably by clamping forces.

In summary, it may be stated that the blocking device 100 in accordance with the embodiments can fix a decoupling device 22 in position and in particular limit the maximum permissible loads on it. The constituent parts of the blocking device 100 in accordance with the embodiments can easily be manufactured from plastic. The usual materials, such as polypropylene, polyethylene, polyamide, etc., can be used for the blocking device 100. Such plastics are durable, mechanically stable and inexpensive to process. It is of course also possible to use metal at greater cost, in order to produce corresponding blocking devices 100.

### LIST OF REFERENCE SIGNS

100 blocking device
10 blocking extension, cover, plate
10a stabilizing structure
12 holding portion, strut
14 anti-twist holding projection, clamping region, accumulation of material
14a strut securing projection, accumulation of material
16 passage opening for connecting element, retaining bolt
18 sleeve
18a flattened region on the outer circumference
20 gap
22 functional element, decoupling device, damping device
24 outer connector sleeve
24a inner connector sleeve
26 permanently elastic elastomer portion

1. A blocking device for a functional element comprising:
a predetermined free space for the functional element;
a blocking extension which is expanded perpendicular to a cylinder axis;
at least one holding portion which extends along the cylinder axis; and
at least one accumulation of material for fixing the functional element.

2. The blocking device according to claim 1 wherein the functional element comprises at least one of a damping device or a decoupling device.

3. The blocking device according to claim 2, wherein two blocking extensions are provided opposite each other.

4. The blocking device according to claim 3 wherein the two blocking extensions comprise a cover.

5. The blocking device according to claim 1 wherein the blocking extension comprises two holding portions which extend along the cylinder axis.

6. The blocking device according to 1 wherein the holding portions comprise a strut.

7. The blocking device according to claim 3 wherein the blocking extension comprises two holding portions which extend along the cylinder axis and are preferably embodied as a strut.

8. The blocking device according to 3 wherein the holding portions comprise a strut.

9. The blocking device according to any one of claim 1, wherein the blocking extension comprises a central passage opening which is equipped on its inner circumference with projections configured to hold the functional element.

10. The blocking device according to any one of claim 2, wherein the blocking extension comprises a central passage opening which is equipped on its inner circumference with projections configured to hold the functional element.

11. The blocking device according to any one of claim 3, wherein the blocking extension comprises a central passage opening which is equipped on its inner circumference with projections configured to hold the functional element.

12. The blocking device according to any one of claim 4, wherein the blocking extension comprises a central passage opening which is equipped on its inner circumference with projections configured to hold the functional element.
